(19) United States
(12) Patent Application Publication
(10) Pub. No.: US 2018/0012177 A1
(43) Pub. Date: Jan. 11, 2018

(54) COST-EFFECTIVE TRACKING

(71) Applicant: HANHAA LIMITED, London (GB)

(72) Inventor: Azhar Hussain, London (GB)

(21) Appl. No.: 15/547,417

(22) PCT Filed: Jan. 29, 2016
(86) PCT No.: PCT/GB2016/050193

§ 371 Date: Jul. 28, 2017

(30) Foreign Application Priority Data
Jan. 29, 2015 (GB) 1501482.2

(51) Int. Cl. G06Q 10/08; G06K 7/10; G06Q 50/32; H04W 4/04

(52) U.S. Cl. CPC G06Q 10/0833; H04W 4/04; G06K 7/10188; G06Q 50/32

(57) ABSTRACT

A tag comprising a communication unit configured to receive a signal representative of postal information and an information provisioning unit configured to make the postal information available to a postal service so as to facilitate transportation of the tag by said postal service.

This invention relates to a tag and an apparatus for remotely monitoring and/or controlling the tag.

One of the side effects of the growth in internet shopping and internet auction sites is that an increasing number of parcels are sent via postal services such as national carriers, courier services and other carriers. Some of these postal services offer tracking services that enable the sender to check when a parcel reaches its destination. This provides reassurance for the sender and also provides evidence of delivery in the event of any dispute about whether the parcel arrived or not. Tracking services such as these are normally only offered by courier services, which are expensive. It would be advantageous for users if they were able to track parcels to their destination irrespective of which postal service they choose to deliver it. Also, tracking services tend to be proprietary to a particular postal service. This is an inflexible arrangement that makes it difficult to track parcels from originating location to destination if that journey involves more than one postal service. Even where interoperability between the different proprietary tracking services is possible, it tends to be very expensive to achieve.

Some companies use tracking devices to track shipments of goods and materials as they are transported around the world. These tracking devices tend to form part of a sophisticated logistics network and are generally owned by the companies themselves. They are too expensive for more domestic applications. For example, the cost would be prohibitive if an individual or small business were to purchase such a tracking device for one parcel. These type of users also lack the infrastructure required to track the device. Therefore, there is a need for an improved mechanism for tracking parcels and the like, particularly since there is an increasing need for flexible tracking of an individual parcel to any given destination, even if that journey is achieved via more than one distribution network.

According to a first embodiment, there is provided a tag comprising a communication unit configured to receive a signal representative of postal information and an information provisioning unit configured to make the postal information available to a postal service so as to facilitate transportation of the tag by said postal service.

The tag may comprise a location unit configured to gather data indicative of a location of the tag.

The communication unit may be configured to transmit a location signal, from which an indication of the tag's current location can be determined, to a tracking apparatus.

The communication unit may be configured to periodically transmit the location signal.

The communication unit may be configured to transmit the location signal at time intervals that are dependent on the current location of the tag relative to a destination of the tag.

The communication unit may be configured to transmit the location signal at time intervals that are shorter the closer the tag is to its destination.

The tag may comprise a user interface and the communication unit is configured to start transmitting the location signal in dependence on a user input received via the user interface.

The communication unit may be configured to receive postal information that is dependent on the tag's current location.

The communication unit may be configured to receive postal information that will facilitate the tag being returned to a tag provider via the postal service.

The information provisioning unit may comprise a display configured to display postal information.

The information provisioning unit may comprise an e ink display.

The communication unit may be configured to receive postal information that includes an indication of a physical address.

The communication unit may be configured to receive postal information that includes an indication that a payment due to the postal service for transporting the tag has been paid.

The communication unit may be configured to receive postal information that includes a representation of a postage stamp.

The tag may comprise a user interface and the communication unit is configured to transmit an indication that the tag has reached its final destination responsive to a user input received via the user interface.

The communication unit may be configured to receive the postal information responsive to the indication that the tag has reached its final destination.

The communication unit may be configured for cellular mobile communications.

The tag may comprise one or more sensors configured to sense a condition of the tag.

According to a second embodiment, there is provided an apparatus comprising a location unit configured to determine a location of a tag in dependence on a location signal received from that tag and a postal provisioning unit configured to transmit, to the tag, postal information that is dependent on the location of the tag so as to facilitate transportation of the tag by a postal service when that postal information is made available to the postal service.

The postal provisioning unit may be configured to transmit postal information that will facilitate the tag being returned to a tag provider via the postal service.

The postal provisioning unit may be configured to transmit postal information that includes an indication of a postal address.

The postal provisioning unit may be configured to transmit postal information that includes an indication that that a payment due to the postal service for transporting the tag has been paid.

The postal provisioning unit may be configured to transmit postal information that includes a representation of a postage stamp.

The location unit may be configured to determine that the tag has reached a destination associated with the tag.

The location unit may be configured to determine that the tag has reached its destination in dependence on a signal, from the tag, indicating that a user of the tag has confirmed to the tag that it has reached its destination.

The postal provisioning unit may be configured to, responsive to the tag reaching its destination, transmit the postal information.

The location unit may be configured to track the location of the tag in dependence on one or more location signals received from the tag.

The location unit may be configured to provide an indication of the location of the tag in response to a request from a third party.

According to a third embodiment, there is provided a method for facilitating transportation of a tag by a postal service comprising the tag wirelessly receiving a signal representative of postal information and making the postal information available to a postal service so as to facilitate transportation of the tag by said postal service.

According to a fourth embodiment, there is provided a method for facilitating transportation of a tag by a postal service comprising determining a location of the tag and transmitting, to the tag, postal information that is dependent on the location of the tag to facilitate transportation of the tag by a postal service when that postal information is made available to the postal service.

According to a fifth embodiment, there is provided a tag comprising one or more sensors that are configured to sense a condition of the tag at times spaced by an update interval, a location unit configured to determine an indication of a current location of the tag and a sensor control unit configured to control the update interval in dependence on the current location of the tag.

The location unit may be configured to determine an indication of the current location of the tag relative to a destination of the tag.

The sensor control unit may be configured to control the update interval in dependence on the current location of the tag relative to the destination of the tag.

The sensor control unit may be configured to control the update interval to be shorter the closer the current location of the tag is to its destination.

According to a sixth embodiment, there is provided a tag comprising one or more sensors configured to sense a condition of the tag at times spaced by an update interval, a communication unit for wirelessly receiving a control signal and a sensor control unit configured to control the update interval in dependence on the control signal, to thereby enable said update interval to be controlled remotely.

The tag may comprise a component configured to: before it is determined that the tag has reached its destination, perform function that is not part of a user interface of the tag; and after it is determined that the tag has reached its destination, perform a function that is part of a user interface of the tag by gathering data indicative of a user input.

The tag may be configured to interpret an output of one or more of the sensors as being indicative of a user input.

The tag may be configured to interpret the output of an accelerometer as being indicative of a user input.

The present invention will now be described by way of example with reference to the accompanying drawings. In the drawings:

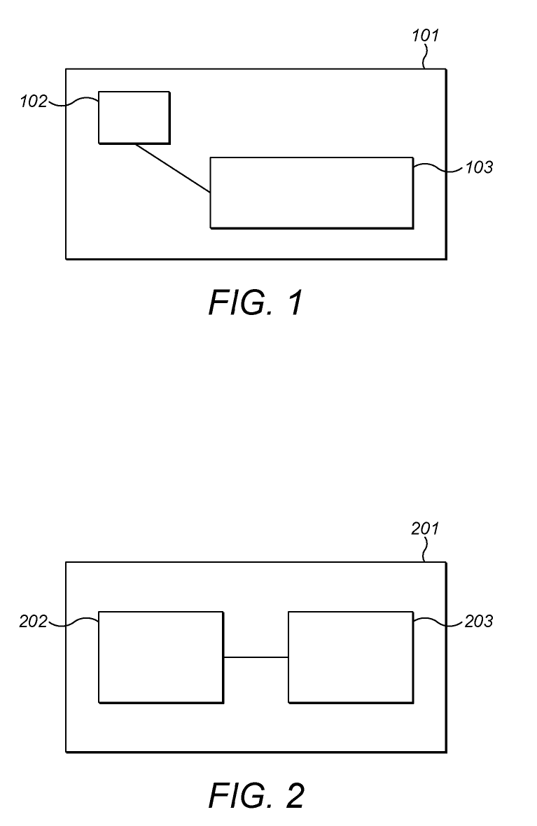

FIG. 1 shows an example of a tag;

FIG. 2 shows an example of an apparatus for providing postal information to a tag;

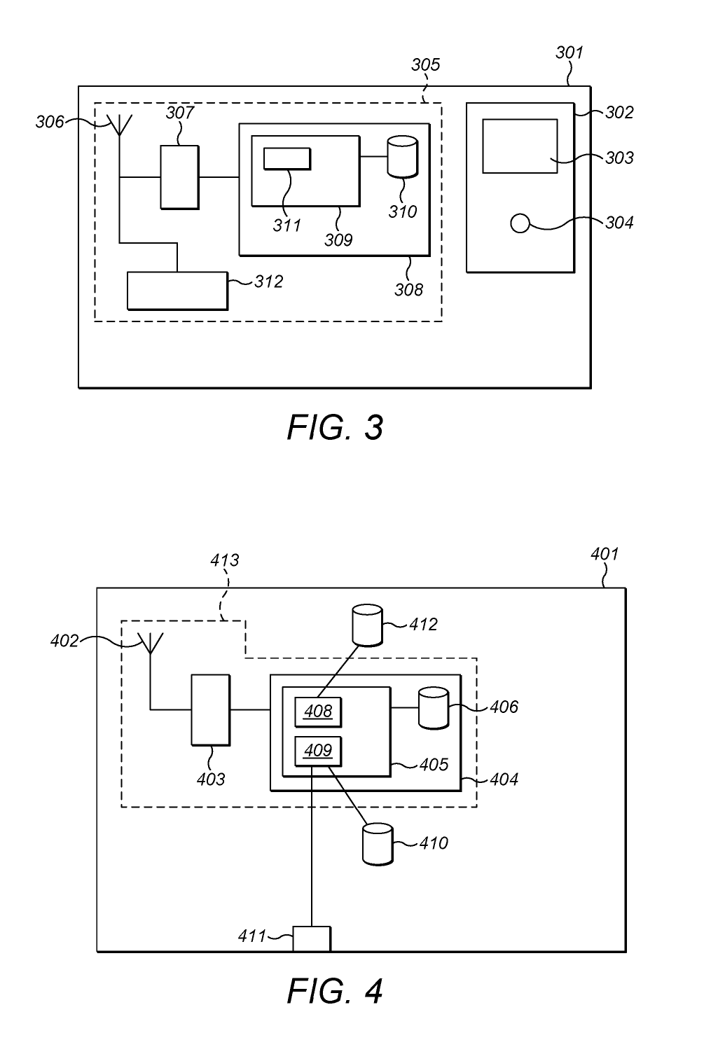

FIG. 3 shows an example of a tag configured to receive postal information;

FIG. 4 shows an example of a tracking apparatus;

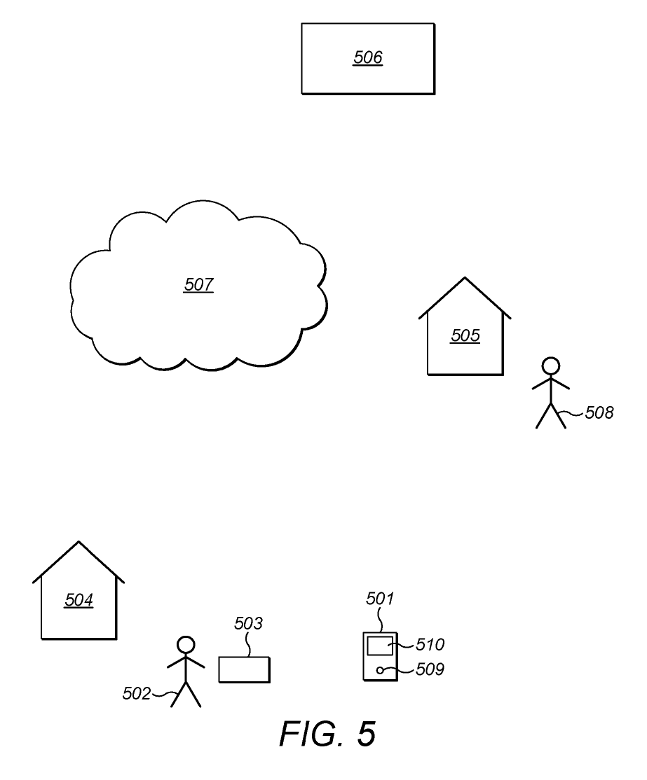

FIG. 5 shows an example of a parcel being tracked by a tag;

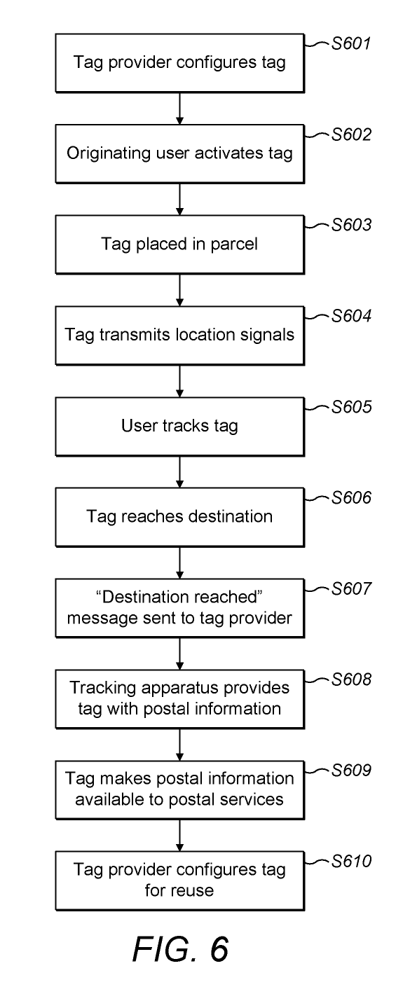

FIG. 6 shows an example of a method for tracking a parcel;

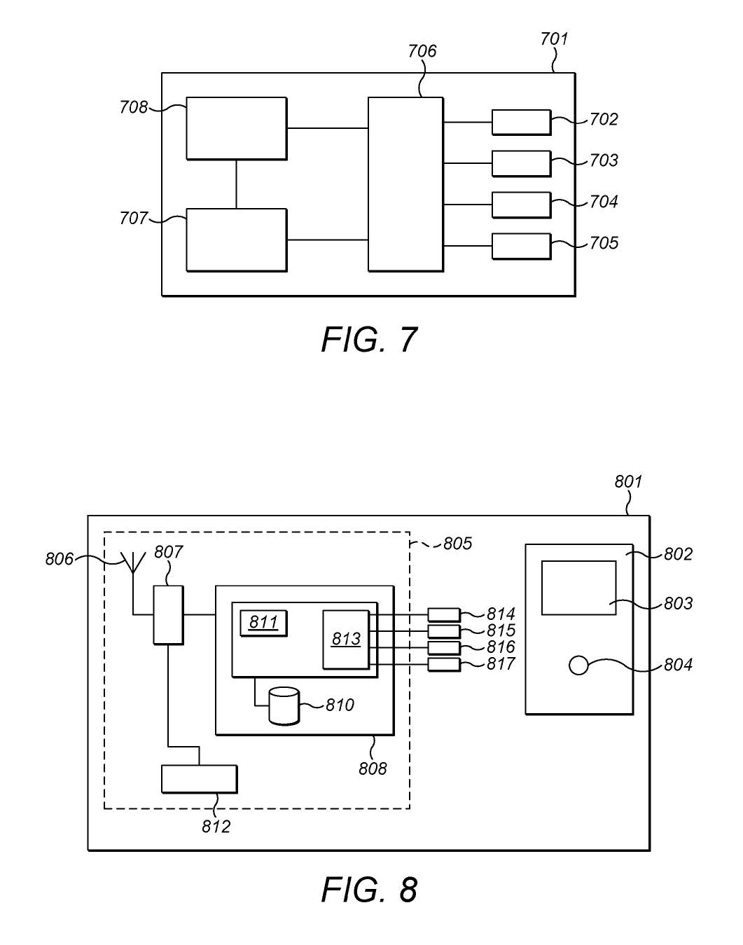

FIG. 7 shows an example of a tag;

FIG. 8 shows an example of a tag configured to adjust the update interval on one or more sensors; and

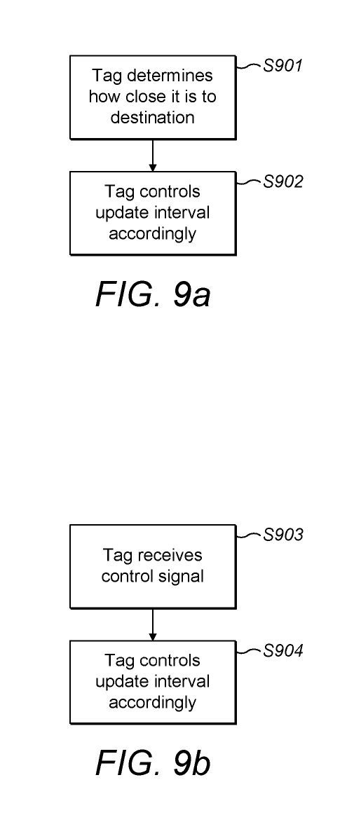

FIGS. 9a and b show an example of methods of controlling the update interval of one or more sensors.

An example of a tag is shown generally at 101 in FIG. 1. The tag comprises a communication unit 102. This communication unit is preferably configured for wireless communication, although wired communication is also possible. The communication unit 102 is configured to receive a signal representative of postal information. This signal could, for example, include data representing a postage stamp or a postal address. The tag 101 also includes an information provisioning unit 103. The information provisioning unit is preferably configured to make the postal information received by the communication unit available to a postal service. The term “postal service” is intended to encompass any company, person or machine engaged in the business of collecting, despatching, transporting and/or delivering items. It encompasses, for example, both domestic post and business-to-business supply chains. Preferably the information is made available in a form that is directly accessible to humans. For example, the information provisioning unit might include a visual indicator for presenting information visually, such as a light, display, screen or switch, or it might include a speaker for outputting the information audibly or a vibrator for outputting information by vibration. Another option is for the information to be made available in machine-accessible form. For example, the tag might include a transmitter or wired port for outputting the information as electronic data, which might then be detected by some type of portable reader such as a scanner. The tag could make postal information available in both human and machine-accessible form. Making the postal information available externally of the tag should facilitate transportation of the tag by the postal service.

An example of an apparatus for providing postal information to a tag is shown in FIG. 2. The apparatus is shown generally at 201. It comprises a location unit 202, which is configured to determine a location of a tag. The location unit is preferably configured to perform this location determination in dependence on a location signal received from the tag. This location signal encompasses any signal from which the apparatus can derive information relevant to the tag's location. The apparatus also comprises a postal provisioning unit 203. This unit is configured to transmit postal information to the tag. Postal information encompasses any data that should facilitate transportation of the tag by a postal service. For example, it may include a postal address and/or postage stamp. The term “postage stamp” is used herein to indicate any data, code, visual representation or otherwise that acts as evidence that a postal service has been paid for, including conventional a stamp, a license key or a freepost tag.

The apparatus may be implemented in whole or in part by some form of computing device, such as a PC, laptop or server. The computing device may incorporate a communication unit similar to communication unit 102 in the tag, or may just be connected to receive data from such a communication unit. In some implementations, the apparatus might be implemented in whole or in part by processors that form part of the cloud.

The structures shown in FIGS. 1 and 2 (and indeed all block apparatus diagrams included herein) are intended to correspond to a number of functional blocks in an apparatus. This is for illustrative purposes only. FIGS. 1 and 2 are not intended to define a strict division between different parts of hardware on a chip or between different programs, procedures or functions in software. In some embodiments, some or all of the algorithms described herein may be performed wholly or partly in hardware. In many implementations, at least part of communication unit 102, information provisioning unit 103, location unit 201, and postal provisioning unit 203 may be implemented by a processor acting under software control (e.g. the CPU of a communication device). Any such software is preferably stored on a non-transient computer readable medium, such as a memory (RAM, cache, hard disk etc) or other storage means (USB stick, CD, disk etc).

One advantage of the arrangement described above is that the tag can be remotely configured for posting. The person who posts the tag does not have to provide postal information, such as address and postage stamp. This also means that postage can remain under the control of a third party to a large extent. This facilitates an arrangement in which the tag is not owned by the person who uses or posts it, but by a third party tag provider who would like the tag returned to them so that it can be reused. Another advantage of the tag is that is it can be automatically configured for posting at the time when it is due to be posted. The postal information can thus be tailored to the tag's current circumstances, such as its location or condition, or to other relevant circumstances, such as a status of the third party tag provider's distribution centres.

Some implementations of the tag and apparatus will now be described in more detail with reference to a specific application in which the tag is used for tracking an object. This is just an example of one application in which the automatic configuration of the tag with postal information is useful. It should be understood that the tag is not limited to being used in this specific application since it could be used in many other scenarios. It should also be understood that any of the features of the tag or apparatus described below with reference to this tracking application can equally well be applied to any other application in which they might be deployed.

The tracking tag is a simple device, shown generally at 301. It is preferably configured in size and weight to that it can be straightforwardly incorporated into an object whose location is to be tracked. In many implementations this object will be a parcel, so the tag is suitably small and lightweight. For convenience the description below refers to tracking parcels but it should be understood that the tag might be used to track any object. The object could be living or non-living. It could include valuables, foodstuffs, and other speciality shipments, including those relating to the biological and pharmaceutical or pharmacological industries.

The tag incorporates a straightforward user interface, shown generally at 302. In this particular example the user interface includes a display 303 and a button 304. The user interface may be configured differently. For example, the display might implement a touch screen, in which case button 304 might be dispensed with. Another possibility would be for the tag to incorporate a microphone and voice recognition software so that it is responsive to voice commands. In some implementations the display may implement the information provisioning unit shown in FIG. 1. The display may be configured to display an address or postage payment information, such as a representation of a stamp. The display is preferably robust and relatively low power.

An e ink display would be suitable. Other interfaces might also be used, including interfaces incorporating raised type for visually impaired users or audio interfaces.

The tag is configured for wireless communication. The device of FIG. 3 has a communication unit 305 that comprises an antenna 306, a radio frequency front end 307 and a baseband processor 308. The baseband processor comprises a microprocessor 309 and a non-volatile memory 310. The non-volatile memory 310 stores in non-transitory form program code that is executable by the microprocessor to cause the baseband processor to implement the communication protocol of a wireless network. The protocol may be any suitable wireless protocol, such as GSM, 3G, 4G, WiFi, Bluetooth, Bluetooth LE, Zigbee, ibeacon etc.

Microprocessor 309 may also be efficiently used to implement other functional units of the tag. For example, the non-volatile memory 310 also stores in non-transitory form program code that is executable by the microprocessor to implement the location unit 311. This may include program code that is executable by the microprocessor to cause the location unit to trigger a location data gathering operation by the communication unit, such as transmitting a roaming signal or location beacon. It may also include code to cause the location unit to implement one or more location algorithms, so that any location-related data can be processed by the location unit before it is transmitted by the communication unit to a tracking apparatus.

The tag may also be configured to switch its network identity based on rules that are either internal or external to the tag. This will allow the tag to switch between different network providers, depending on the rules governing the tag's location or state at the time. The rules might be stored on the tag or could be updated over the air interface at the request of the tag. Similarly the tag's different network identities might be stored on the tag or could be updated over the air interface at the request of the tag.

Optionally the tag may also include a short range radio transmitter 312, which in this example is shown sharing the antenna 306. This transmitter might be used to broadcast information to the postal services, delivery personnel or other interested parties. This information might include postal information or just general information about the tag or the object the tag is being used to track. Relevant information might include an identity associated with the tag, parcel or other object, the destination of the tag, information detected by sensors in the tag etc. The broadcast information might then be detected by an appropriate radio receiver without having to open the parcel or isolate the parcel from a consignment of many other parcels.

An example of a tracking apparatus is shown in FIG. 4. The apparatus 401, like the tag in FIG. 3, is configured for wireless communication by means of communication unit 413. The device of FIG. 4 comprises an antenna 402, a radio frequency front end 403 and a baseband processor 404. The baseband processor comprises a microprocessor 405 and a non-volatile memory 406. The non-volatile memory 407 stores in non-transitory form program code that is executable by the microprocessor to cause the baseband processor to implement the communication protocol of a wireless network. The protocol may be any suitable wireless protocol, such as GSM, 3G, 4G, WiFi, Bluetooth, Bluetooth LE etc.

Microprocessor 405 may also be efficiently used to implement other functional units of the tag. In this example the non-volatile memory 407 also stores in non-transitory form program code that is executable by the microprocessor to implement the location unit 408 and the postal provisioning unit 409. In other implementations the location unit and postal provisioning unit may be implemented by a different microprocessor than that which implements the communication unit. For example, the communication unit could be comprised in a communication device connected to a separate general-purpose computing device that is configured to implement the location unit and the postal provisioning unit.

The postal provisioning unit 409 has access to a database 410, which is suitably configured to store postal addresses and/or representations of postage stamps. The postal provisioning unit 409 may also have access (e.g. via wired port 412) to external data, such as information about the state of a tag provider's infrastructure or information provided by one or more postal services. The location unit may implement one or more location algorithms for processing location-related data from the tag (particularly where relatively raw location data is provided by the tag itself). The location unit may be configured to generate appropriate tracking data from the location data. The tracking data is suitably generated to be readily understandable by a human user.

In FIG. 5, the location unit comprises database 412 for storing tracking data. The location unit may also be configured to forward tracking data onto other functional units within the tracking apparatus so that appropriate tracking data can be provided to the tag's originating user. In some embodiments, tracking data could also be provided to the destination user. For example, in FIG. 5, the location unit is connected to both the wireless communication unit and the wired port 411.

An example scenario in which a tag is used to track a parcel is shown in FIG. 5. The tag 501 is initially in possession of originating user 502 at originating location 504. Originating user 502 intends to use tag 501 to track parcel 503 as it is transported by a postal service to destination 505 and destination user 508. The tag is tracked by tracking apparatus 506 via wireless network 507.

In the scenario shown in FIG. 5, the tag is likely to be owned by a tag provider, rather than the user. The tag provider configures the tag so that its location can be tracked. It also provides the tracking service, including necessary infrastructure (such as the tracking apparatus). The tag provider then allows a user to use the tag, most likely for a length of time that is determined by a fee paid by the user. Thus the user effectively leases the tag. All the user then needs to do is activate the tag and put it in a parcel. The originating user is then able to track the tag (and the associated parcel) via tracking information provided by the tag provider. Once the tag reaches its destination, the tag is automatically for return postage by the tag provider so that the person who receives the parcel can return the tag to the tag provider by putting it in the post.

The cost of the “lease” is preferably less than the cost of buying the tag. This enables the tracking service to become accessible to users who would find it too expensive to buy their own tag, particularly given that they are likely to want to track relatively few parcels a year. The cost per tracking operation should be lower for the tag provider than the cost of buying the tag if the tag provider is able to lease the same tag many times over. This is achievable provided there is a mechanism by which the tag can be returned to the tag provider after use. Automatically providing the tag with postal information when it reaches its destination helps with this. It makes it very easy for the destination user to return the tag—it only needs to be put in a postbox—making it more likely that that tag will be returned. The tag provider may provide incentives to encourage the tags to be returned, such as reward points, future discounts or a partial refund on a previous purchase. It also makes it possible for the tag provider to remotely configure the tag with the postal information that is most appropriate at the time and given the location of the tag.

An example of a method for tracking a parcel and delivering postal information to the tag is shown in FIG. 6.

First the tag provider configures the tag (step S601). This may involve generally configuring the tag to have wireless communication capabilities, location-determination capabilities and optionally one or more sensors. It may also involve configuring the tag more specifically for a particular type of tracking operation. For example, charging the tag's battery so that the tag will remain active for a particular period of time. This time period may be selected to enable the tag to track for a particular time and/or distance, rendering it suitable for tracking parcels objects to a particular type of destination under normal circumstances. The tag is therefore likely to be leased at a price that is determined by factors such as the type of destination, the type of postal service being used (e.g. national carrier, courier or other private provider), class of delivery, whether the delivery service is guaranteed within a certain time period etc.

The tag provider may also configure the tag's appearance. If the tag has a display, for example, the tag provider may initially configure it to initially display user instructions, marketing information or the like.

The tag is then “activated” by the originating user. This places the tag into a state in which it is able to track the parcel (step S602). For example, the user 502 at the originating location 504 might just be required to press a button 509 on the front of the tag. The battery life of the tag is likely to be limited, so it is preferred that the tracking components in the tag are only switched on when the originating user activates the tag. Once activated, the tag is placed in or attached to the parcel 503 (step S603). The parcel is then dispatched towards its destination 505, e.g. by passing it to a postal service.

The tag 501 suitably transmits location signals to a tracking apparatus 506 from time-to-time throughout its journey (step S604). The tag preferably transmits its location signals wirelessly, e.g. via wireless network 507. The tag may work out its own location, and transmit this to the tracking apparatus, or it may just gather information relevant to its location, transmit it, and leave the tracking apparatus to perform the location calculations. This may involve the tag transmitting some kind of roaming signal or tracking beacon. What location information is relevant will depend on the location tracking mechanism used by the tag and the tracking apparatus. A preferred, low-cost implementation makes use of cellular technology, such as GSM. Relevant information may include a cell or base station identification, base station signal strengths, time-of-flight data etc. Other positioning systems such as GPS might equally be used, in which case the relevant information may include time-of-arrival of the pseudo-random GPS code at the tag, the position of the relevant satellite etc. The exact type of positioning system used is suitably selected based on the application. For parcel tracking, a low cost service is likely to be more important than precise position information. A GSM-based service is therefore likely to be more appropriate than GPS at present, due to the relative cost of the components required. As the cost of GPS drops and its capabilities extend, and also as other location networks go live, the tag may be adapted to incorporate the required functionality for utilising those networks.

The tag may be configured to transmit location signals at regularly spaced time intervals. To save power, another option is for the tag to send location updates when something significant has happened in its journey, e.g. it has handed off from one base station to another or has been handed off from one mobile provider to another. Also many users will only be interested in the tag's location when it can be expected to be approaching its final destination. The tag may therefore be configured to transmit location updates at shorter time intervals the closer it is to its destination. Another option is for the tag to send a location update responsive to a request from the tracking apparatus. The request could, for example, be triggered by an update request from the originating user.

In a preferred embodiment, the tag is configured to gather location information via the same wireless network 507 that it uses to transmit location signals to the tracking apparatus. This helps to limit the number of components required and thus reduce costs. In many implementations it is likely that the tracking apparatus 506 will be operated by a different entity from the wireless network 507. The tracking apparatus 506 is suitably operated by the tag provider. The tag provider may be different from both the originating and destination users 502, 508. The tag could also use other radio signals, such as WiFi or FM radio etc. to help substantiate its location. Location determination is also not limited to a single radio network: the tag could gather location information from multiple networks.

The originating user 502 is able to track the parcel by contacting the tag provider for an update on the location of the tag (step S605). In some embodiments the destination user may also be able to contact the tag provider for an update on the tag's location. Location updates may be provided to a user by any suitable mechanism, e.g. via a website. Preferred embodiments enable a user to obtain location updates with minimal internet connectivity and/or technical difficulty. For example, the user may be provided with specific contact details when they lease the tag from the tag provider, such as email address, telephone or pager number, twitter account or hashtag. The user then simply sends a message to those contact details to receive a location update in return. That return message may, for example, take the form of an email, tweet, page, SMS message etc. Another option is for the tracking apparatus to send the user regular location updates without the user having to request them. Those location updates may be sent at regular intervals or only at times when the tag is considered to have reached a significant point in its journey, e.g. entering a different country or reaching its destination. Location updates may also be sent to the user more frequently as the tag approaches its destination.

The location updates are preferably sent in a user-friendly form. The tracking apparatus may convert the location data it has about the tag (e.g. coordinates) into tracking data that will be easily understood by the user. Options include showing the tag's location as a position on a map, giving the closest town to the tag's destination, a postcode or associated street address etc. The tracking apparatus may also provide the originating user with more detailed tracking data the closer the tag is to its destination. For example, the originating user may be provided with the name of the closest town during the majority of the tag's journey and an approximate street address as the tag approaches its destination.

The tag eventually reaches its destination 505 (step S606). The destination user 508 preferably indicates to the tag and the tag provider that the tag has reached its destination by pressing button 509. Pressing this button causes the tag to send a message to the tracking apparatus 506 to inform it that it has reached its destination (step S607). In response, the tracking apparatus generates the necessary postal information (step S608). Preferably this postal information is of a type to facilitate the tag being transported by the postal services to a different location from its current location.

In some applications it may be useful to gather data from the destination user about the condition in which the parcel reached its destination. This data is suitably entered into the tag by the destination user via a user interface such as one or more buttons, a touch screen, microphone and associated voice recognition software etc. One option is for a series of questions to be displayed on the tag's screen or output by a loudspeaker to which the destination user can answer “yes” or “no”. If the tag only has one button, the user may be able to distinguish between “yes” or “no” by pressing the button either once or twice. The tag could also gather user input using a component whose primary use is not as part of a user interface. The tag may be configured to interpret the output of that component as representing a user input once the destination user has indicated to the tag that it has reached its destination. For example, if the tag comprises an accelerometer, the destination user could provide user input by shaking the tag once he has pressed the button to indicate that the tag has reached its destination. In this implementation, the tag may be configured to take the output of the accelerometer as representing a “no” if the tag is shaken and the pressing of the button as representing a “yes” (or vice versa).

In a preferred embodiment, the postal information is generated in dependence on the location of the tag. For example, the tag provider may have depots in different countries for collecting the tags, in which case the tracking apparatus may extract the address of the most appropriate depot from a database. This also enables the tag provider to provide timely information. For example, if the most appropriate depot from a geographical perspective is out of operation or overloaded when the tag is received, the tag provider simply provides the tag with the postal address of the most suitable alternative. Similarly the tracking apparatus may provide the tag with data that is capable of representing a suitable postage stamp for the tag to be returned to the tag provider via one or more postal services. That data might be an alphanumeric code, for example, or a barcode or QR code.

On receiving the postal information, the tag 501 makes it available in such a way that it can be accessed from outside the tag (step S609). For example, tag 501 may display the postal address and/or postage stamp representation that it has received from tracking apparatus 506 on its screen 510. The relevant information could also be broadcast by a transmitter or made available externally of the tag in any suitable fashion. Once the tag has been automatically configured by the tracking apparatus for being returned to the tag provider, the destination user 508 can return it by simply handing it to the appropriate postal service (e.g. by putting it in a post box).

When the tag is received back by the tag provider, the tag provider suitably reconfigures it so that it can be provided to another user (step S610). This might just involve recharging the battery so that the tag can be re-leased.

Another implementation of a tag is shown in FIG. 7. This tag might be implemented completely independently of either of the tags described above, or it might incorporate one or more features of any of the tags described above.

FIG. 7 shows an implementation of a tag that comprises for sensing a condition of the tag. The tag, shown generally at 701, comprises four different sensors, each of which is configured to sense something different. In this example, the sensors include an accelerometer 702, a temperature sensor 703, a humidity sensor 704 and a light sensor 705 but any sensors might be used. The output from these sensors give an indication of the condition of the tag, either because they sense something about the environment surrounding the tag or because they can provide information about something that has happened to the tag (e.g. that it has been dropped). The sensor outputs are preferably also indicative of the condition of an object, such as a parcel or shipment of goods, to which the tag is attached.

Each sensors is configured to perform a sensing operation and generate an output at certain time intervals. This is termed the “update interval” herein, and preferably it is adjustable. The tag includes a sensor control unit 706, which is configured to control the update interval of the sensors. The update intervals of the sensors may be individually controllable or they may be controlled as a group.

The update interval may be controlled in dependence on a number of different factors. The tag in FIG. 7 comprises an optional communication unit 707. This communication unit is preferably configured for wireless communication, although wired communication is also possible. The communication unit 707 is configured to receive instructions from an external entity, such as a tag provider, that sets the update interval. The communication unit is preferably configured to pass these instructions to the sensor control unit 706, which is configured to control the update interval of one or more of the sensors in dependence on those instructions. The communication unit thus provides a means for remotely controlling the update interval of the sensors.

The tag in FIG. 7 also comprises an optional location unit 708, which is configured to determine an indication of the current location of the tag. The location unit is configured to pass the indication of the tag's location to the sensor control unit, which may be configured to control the update intervals of the sensors in dependence on the current location of the tag. The reasoning is that sensor updates are more likely to be of interest at certain points during the tag's journey and particularly as it approaches its destination. It may therefore be possible to save power by controlling the sensors to update less frequently during parts of the journey that are not of much interest. The update interval can be controlled to be shorter the closer the tag gets to its destination. The location unit may therefore also be configured to determine an indication of the current location of the tag relative to its destination. The location unit may determine this indication based on its own observations, or based wholly or partly on information received from a tag provider or other external entity (such as tracking apparatus 506).

The location unit and the communication unit are both optional. A tag might comprise just one or the other, or a tag might comprise both.

The structures shown in FIG. 7 (and indeed all block apparatus diagrams included herein) are intended to correspond to a number of functional blocks in an apparatus. This is for illustrative purposes only. FIG. 7 is not intended to define a strict division between different parts of hardware on a chip or between different programs, procedures or functions in software. In some embodiments, some or all of the algorithms described herein may be performed wholly or partly in hardware. In many implementations, at least part of communication unit 707, sensor control unit 706 and location unit 708 may be implemented by a processor acting under software control (e.g. the CPU of a communication device). Any such software is preferably stored on a non-transient computer readable medium, such as a memory (RAM, cache, hard disk etc) or other storage means (USB stick, CD, disk etc).

The tag shown in FIG. 7 might be used for tracking an object in a similar way as the tag shown in FIG. 3. An example of a tracking tag of this kind is shown in FIG. 8. The tag is identical to the tag shown in FIG. 3, but with the addition of sensors 814 to 817 and sensor control unit 813. As with the tag in FIG. 3, microprocessor 808 may be efficiently used to implement other functional units of the tag than the communication unit. The sensor control unit is therefore suitably implemented by microprocessor 809 acting under the control of non-transitory form program code stored by non-volatile memory 810. The program code suitably causes the microprocessor to control an update interval of one or more of sensors 814 to 817 in dependence on control information received via communication unit 805 and/or in dependence on information about how close the tag is to its destination, in dependence on information output by location unit 811 and/or received externally via communication unit 808. The operation of the other functional units in FIG. 8 is identical to that in FIG. 3 (including antenna 806, radio frequency front end 807, baseband processor 808, location unit 811 and short-range transmitter 812).

The tracking tag shown in FIG. 8 may be configured to adapt its update intervals in dependence on location information received from the tracking apparatus 401 shown in FIG. 4. The tracking apparatus may also issue direct controls to the tracking tag to cause it to change its update intervals. For example, the tracking apparatus may instruct the tag to shorten its update interval if it determines that the tag is approaching its destination. Instructions of this kind may suitably be issued by location unit 408 of tracking apparatus 401 via communication unit 413. The tracking apparatus might be configured to instruct the tag to change its update interval in dependence on other factors too. For example, if the tracking apparatus determines that the tag's battery may be approaching the end of its charge while the tag is still distant from its location, it may instruct the tag to increase its update interval to conserve battery power.

Examples of two methods for controlling the update interval of a tag are shown in FIGS. 9a and b. In FIG. 9a, the tag determines an indication of how close it is to its destination (step S901). In response to this determination, the tag controls its update interval (step S902). In FIG. 9b, the tag receives a control signal from an external entity such as a tag provider (step S903) and updates controls its update interval accordingly (step S904). These steps might readily be incorporated into a tracking method, such as that shown in FIG. 5, at any point between the tag being activated and the destination user indicating that the tag has reached its destination.

In various embodiments described above, information is exchanged between the tag and the tag provider and the tag provider and a user at varying time intervals depending on how close the tag is to its destination. How close the tag is to its destination could be determined by the tag itself or by an external entity such as a tag provider. It might be determined based on actual location data or based on an indication of location, such as time. Some options include:
The tag or tag provider may assume that the tag is approaching its destination based on the length of time that has elapsed since the tag was activated by the originating user.

The tag could be pre-programmed or remotely controlled by the tag provider to send updates at time intervals that are determined by the length of time that has elapsed since it was activated.

The tag's exact destination will in many applications not be known to the tag or the tag provider. The tag's destination may be therefore be approximated in dependence on a general type of destination that the tag was leased for.

The originating user may tell the tag provider what the final destination of the tag is. The tag provider may provide this information to the tag.

The tag may itself be capable of determining how close it is to its final destination and adjusting one or more update intervals accordingly.

The tracking apparatus may be better placed to determine when the tag is approaching its destination in which case it may transmit this information to the tag, leaving the tag to adjust its update intervals accordingly. Another option is for the tracking apparatus to directly control the tag to send more frequent updates when the apparatus has determined that it is approaching its destination.

The tag described herein is likely to be particularly useful for tracking parcels because of its small size and relatively low cost. The tag could equally well be implemented in other tracking applications, however, including tracking consignments of goods from suppliers that do not have the distribution infrastructure of large companies such as supermarkets available to them. The tags and apparatus described herein are applicable to a wide range of applications, and it should be understood that they are not limited to the specific applications described herein.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A tag comprising:
a communication unit configured to receive a signal representative of postal information generated in dependence on the location of the tag; and
an information provisioning unit configured to make the postal information available to a postal service so as to facilitate transportation of the tag by said postal service;
wherein the postal information facilitates the tag being returned to a tag provider via the postal service.

2. The tag as claimed in claim 1, wherein the tag comprises a location unit configured to gather data indicative of a location of the tag.

3. The tag as claimed in claim 1, wherein the communication unit is configured to transmit a location signal, from which an indication of the tag's current location can be determined, to a tracking apparatus.

4. The tag as claimed in claim 3, wherein the communication unit is configured to periodically transmit the location signal.

5. The tag as claimed in claim 3, wherein the communication unit is configured to transmit the location signal at time intervals that are dependent on the current location of the tag relative to a destination of the tag.

6. The tag as claimed in claim 3, wherein the communication unit is configured to transmit the location signal at time intervals that are shorter the closer the tag is to its destination.

7. The tag as claimed in claim 1, wherein the tag comprises a user interface and the communication unit is configured to start transmitting the location signal in dependence on a user input received via the user interface.

8. The tag as claimed in claim 1, wherein the communication unit is configured to receive postal information that is dependent on the tag's current location.

9. (canceled)

10. The tag as claimed in claim 1, wherein the information provisioning unit comprises a display configured to display postal information.

11. The tag as claimed in claim 1, wherein the information provisioning unit comprises an e ink display.

12. The tag as claimed in claim 1, wherein the communication unit is configured to receive postal information that includes an indication of a physical address.

13. The tag as claimed in claim 1, wherein the communication unit is configured to receive postal information that includes an indication that a payment due to the postal service for transporting the tag has been paid.

14. The tag as claimed in claim 1, wherein the communication unit is configured to receive postal information that includes a representation of a postage stamp.

15. The tag as claimed in claim 1, wherein the tag comprises a user interface and the communication unit is configured to transmit an indication that the tag has reached its final destination responsive to a user input received via the user interface.

16. The tag as claimed in claim 1, wherein the communication unit is configured to receive the postal information responsive to the indication that the tag has reached its final destination.

17. The tag as claimed in claim 1, wherein the communication unit is configured for cellular mobile communications.

18. The tag as claimed in claim 1, wherein the tag comprises one or more sensors configured to sense a condition of the tag.

19. An apparatus comprising:
a location unit configured to determine a location of a tag in dependence on a location signal received from that tag; and
a postal provisioning unit configured to transmit, to the tag, postal information that is dependent on the location of the tag so as to facilitate transportation of the tag by a postal service when that postal information is made available to the postal service.

20. The apparatus as claimed in claim 19, wherein the postal provisioning unit is configured to transmit postal information that will facilitate the tag being returned to a tag provider via the postal service.

21. The apparatus as claimed in claim 19, wherein the postal provisioning unit is configured to transmit postal information that includes an indication of a postal address.

22. The apparatus as claimed in claim 19, wherein the postal provisioning unit is configured to transmit postal information that includes an indication that that a payment due to the postal service for transporting the tag has been paid.

23. The apparatus as claimed in claim 19, wherein the postal provisioning unit is configured to transmit postal information that includes a representation of a postage stamp.

24. The apparatus as claimed in claim 19, wherein the location unit is configured to determine that the tag has reached a destination associated with the tag.

25. The apparatus as claimed in claim 24, wherein the location unit is configured to determine that the tag has reached its destination in dependence on a signal, from the tag, indicating that a user of the tag has confirmed to the tag that it has reached its destination.

26. The apparatus as claimed in claim 24, wherein the postal provisioning unit is configured to, responsive to the tag reaching its destination, transmit the postal information.

27. The apparatus as claimed in claim 19, wherein the location unit is configured to track the location of the tag in dependence on one or more location signals received from the tag.

28. The apparatus as claimed in claim 19, wherein the location unit is configured to provide an indication of the location of the tag in response to a request from a third party.

29. (canceled)

30. A method for facilitating transportation of a tag by a postal service comprising:
determining a location of the tag; and
transmitting, to the tag, postal information that is dependent on the location of the tag to facilitate transportation of the tag by a postal service when that postal information is made available to the postal service.

31-40. (canceled)
